(19) United States
(12) Patent Application Publication
(10) Pub. No.: US 2014/0379633 A1
(43) Pub. Date: Dec. 25, 2014

(54) Electronic Document Approval

(71) Applicants: Sarah M. Banas, Chicago, IL (US); Mark T. Carter, Bedford, TX (US)

(72) Inventors: Sarah M. Banas, Chicago, IL (US); Mark T. Carter, Bedford, TX (US)

(21) Appl. No.: 13/924,605

(22) Filed: Jun. 23, 2013

(51) Int. Cl. G06F 17/30

(52) U.S. Cl. CPC G06F 17/30165
USPC 707/608

(57) ABSTRACT

This invention discloses a method, process, and system for displaying electronic documents that require approval from at least one party, and includes auditable tracing of approvals. The system can be centralized in a web-based or other electronic location, or be integrated as plugin, widgets, or other types of entities in other systems that provide APIs or other methods of integration. The invention presents approval by a person or group as an indication on the original document or as a separate indication. The recipients that are needed to approve the document are sent a notification that there is a document waiting for approval. Approvals are stored for auditing.

### CROSS-REFERENCE TO RELATED APPLICATIONS

Not applicable

### FEDERALLY SPONSORED RESEARCH

Not applicable

### SEQUENCE LISTING

Not applicable

### BACKGROUND OF THE INVENTION

This application refers to electronic documents, specifically electronic documents that require an approval from individuals or a group of recipients, and may include auditable traces of approvals.

### PRIOR ART

The following is tabulation on some prior art that presently appears relevant:

U.S. patents

| patent No. | Issue Date | Patentee |
|---|---|---|
| 2012/0324369 | Dec. 20, 2012 | Safa; John |
| 2011/0154180 | Jun. 23, 2011 | Evanitsky; Eugene; et al. |
| 5,315,504 | May 24, 1994 | Lemble; Philippe |
| 5,850,219 | Dec. 15, 1998 | Kumomura; Akira |

Electronic document approval has been a lucrative attempt at actual approvals. The documents are typically posted in various storage areas for auditing, and then an email is sent out to the users that are required to approve said document. Oftentimes this is clicking in the email system “I approve,” then take that email and post the approval into the document. Even specialty tools require copy and pasting document approvals by each user.

Several types of document approval tools have been proposed—for example, U.S. Patents 2012/0324369 to Safa, John; 2011/0154180 to Evanitsky, Eugene et al.; U.S. Pat. No. 5,315,504 to Lemble, Phillipe; and U.S. Pat. No. 5,850,219 to Kumomura, Akira

Safa's patent involves sending an approval to a recipient list, but having the approval only be on a separate indication of the original document. Each user is forced to approve or reject a document on his or her system. The system itself is forced into being one centralized server

With Evanitsky, the system is limited to a document viewer, and within that viewer, is able to create various annotations. This is not a true document approval system, but simply a method of create annotations within a document.

Regarding Lemble, the system includes electronic mail facilities made available to attached users. The users are required to select to select a form among pre-stored document forms, fill said form in and then have said form mailed for approval by system users selected based on predefined and stored rules. This system complicates the method of approval completely, as the users are forced to create and submit forms for document approval.

Much like Lemeble, Kumomora requires that each document approval is sent by email. This limits the system as it does not consider if emails are never delivered or received by the other party that is required for approval. It is similar to the current methods of document approval.

### DRAWINGS

### Figures

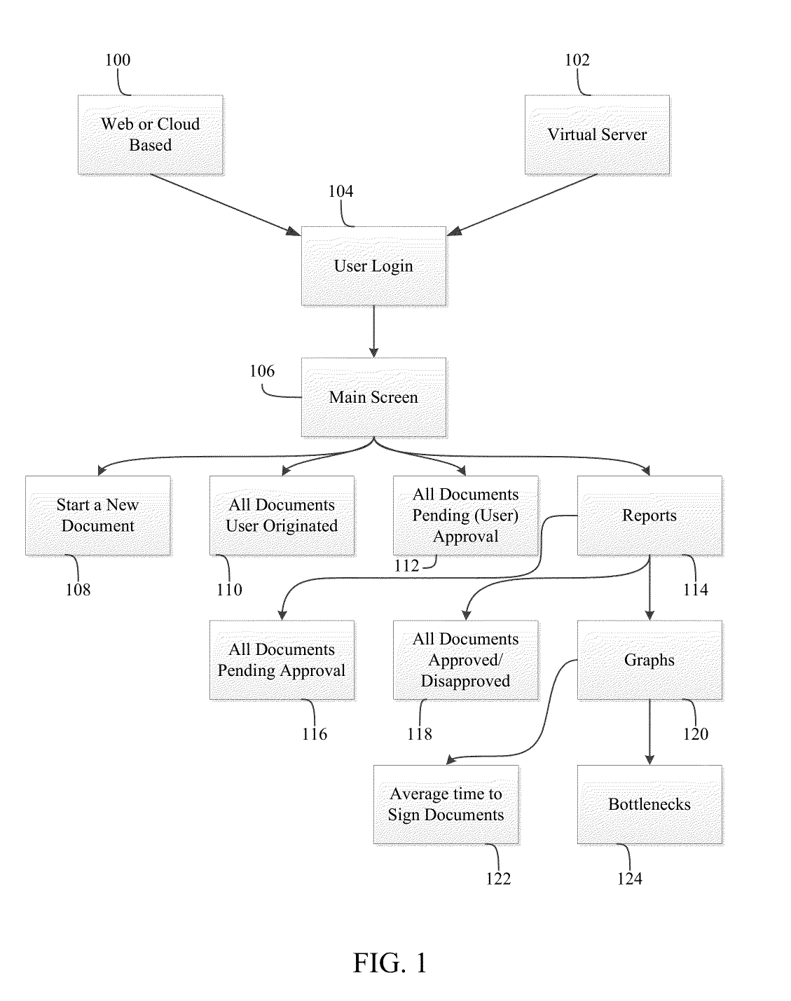

FIG. 1 illustrates a potential system design or layout for the document approval system.

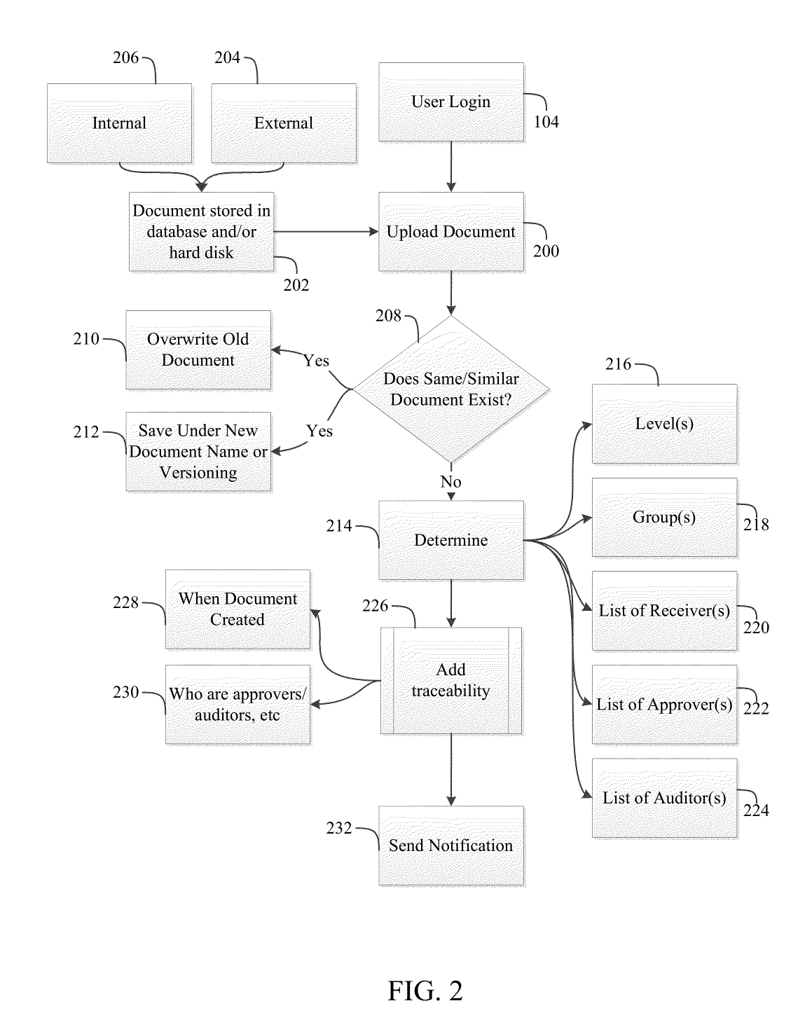

FIG. 2 illustrates a flow chart of the approval or disapproval process.

DRAWINGS—REFERENCE NUMERALS

| | |
|---|---|
| 100 | web or cloud application |
| 102 | virtual server application |
| 104 | user login screen |
| 106 | main screen |
| 108 | option: start a new document |
| 110 | option: show all documents user created |
| 112 | option: show all documents pending |
| | user approval |
| 114 | option: reporting tab |
| 116 | report option: all documents pending |
| | approval |
| 118 | report option: show all document |
| | history of approvals or disapprovals |
| 120 | report option: graphs |
| 122 | graph option: average time by users to |
| | sign documents (all, specific, et cetera) |
| 124 | graph option: show bottlenecks (users |
| | taking too long to approve/disapprove |
| | documents) |
| 200 | Upload document |
| 202 | Store document in database and/or hard |
| | disk |
| 204 | Database and/or hard disk can be |
| | external devices |
| 206 | Database and/or hard disk can be |
| | internal devices |
| 208 | Ask: does a similar or the same |
| | document exist? |
| 210 | If yes, provide option to overwrite old |
| | document |
| 212 | If yes, provide option to save document |
| | under new name or version |
| 214 | If no, determine document factors |
| 216 | Determine: level(s) (C-level, |
| | management, et cetera) |
| 218 | Determine: group(s) (management, IT, |
| | et cetera) |
| 220 | Determine: list of document receiver(s) |
| 222 | Determine: list of document approver(s) |
| 224 | Determine: list of auditor(s) |
| 226 | Add traceability |
| 228 | Sample traceability: when was |
| | document created, by whom |
| 230 | Sample traceability: who are document |
| | approvers, auditors, et cetera |
| 232 | Send notification (e-mail, text message, |
| | et cetera) to users that document |
| | pending approval |

### DETAILED DESCRIPTION

Referring now to FIG. 1, which illustrates a potential layout for the document approval system. The user has to have the ability to login 104 into said document approval system. The system can be a virtual server 102 or a cloud or web-based server 100. The virtual server 102 would have the system pre-installed and optionally pre-configured. Once the client has the virtual server 102 in possession, the client can integrate the approval system within their network. Generally the virtual server would be used internally. The cloud of web-based 100 client is generally a website with the document approval system installed. This client 100 can be accessed anywhere, and can be used as a private or public system.

Once the user logs in 104, the user is presented with a main screen of options 106. The user has the ability to start a new document 108, view all documents the user originated (created or uploaded) 110, view all documents that require the user's approval 112, or view reports 114 that the system produces.

If the user wants to create a new document 108, the user can create any type of document on the system, such as text files, image files, et cetera. These documents can be shared with other users (not necessarily required approval), or downloaded to the user's computer, among other features. The documents are stored on a server.

The approval system also has several features. The user can view all documents that he or she originated 110, as well as see the status related to said document. The statuses include was it approved, who has not approved the document yet, who are the list of auditors, et cetera. With this, the user can also view all documents pending the user's approval 112. A list of documents will be presented to the user that the user must approve or disapprove, regardless if the user originated said documents or were the documents were sent by other users.

Reports 114 are another key feature of the approval system. Reporting 114 allows the user to view and manipulate the data in an easy-to-use manner. Some sample reports included in the approval system are all documents pending approval 116 (including user originated documents, group documents, auditable documents, et cetera). The system can also report all documents approved or disapproved 118 over the course of the user's account. Every document that has been uploaded and sent for approval/disapproval is stored for later retrieval, and the user has the ability to view the document at another time.

Another reporting feature is the graphs 120. These are graphical representations of data or statistics collected for the user. For example, the user can filter out documents by approval time, where he or she can view what is the average time it took to sign specific or all documents 122. This can further be filtered by specific or general groups or specific users, such as seeing how long a user took to approve a document. By doing so, the user has the ability to find bottlenecks 124, or users that take an extra amount of time to approve documents, thereby prolonging the process for other users. The ability to know bottlenecks can help the user or group discuss and manage the problem to quicken the approval process.

Referring now to FIG. 2, which illustrates a flow chart of the approval or disapproval process. The user logs into the system 104. The user can upload a document for approval 200, wherein the document can be a text file, image file, PDF file, or any other file type. The document is stored on the hard disk, database, or other storage device 202 where the storage device can be either an internal 206 or external 204 storage device.

Once the document is uploaded, the system determines whether the document is the same or similar to other documents already uploaded on the system 208. If a document is the same or similar, the user is given the option to either overwrite the old document 210 or to save the document under new name or version 212. The system has the ability to have document version control.

If the document is new or not same as other existing documents, the system can determine 214, among other factors, by level 216, group 218, list of receivers 220, list of approvers 222, or list of auditors 224.

Once determined, the system automatically adds traceability 226 for auditability. The system can trace document from when the document is created 228 to when the user begins adding or removing approvers, auditors, et cetera.

Once the document is completed, the user has the ability to send a notification 232 to the approvers. Notification can be via e-mail, text message, social media, and other methods of notification.

### CONCLUSION, RAMIFICATIONS, AND SCOPE

Thus the reader will see that at least one embodiment of the document approval system provides a more reliable, easier, and more efficient method for approving documents.

While the above description contains many specificities, these should not be construed as limitations on the scope of any embodiment, but as exemplifications of various embodiments thereof. Many other ramifications and variations are possible within the teachings of the various embodiments. Furthermore, the document approval system has the additional advantages in that:
It can be used as a standalone system, either on the web or as part of a company's internal organization;
It can be integrated with existing systems as plugins, widgets, or other methods of interaction or API;
It can notify the uploader or other users of any bottlenecks—any users that are required to approve a document but have not;
It can notify users in the system or via a notification system that files exist that require the user's approval;
It has auditing and tracking abilities;
It has user additions, modifications, commenting, and other user-friendly features;
It does not have to modify the original documents for approval, but can if the author sets the settings to modify original documents;
It allows users to approve or disapprove documents with as simple as a checkbox, there is no need to copy and paste approvals into documents or email or any other electronic or manual method.

Thus the scope should be determined by the appended claims and their legal equivalents, and not by the examples given.

What is claimed is:

1. A system for processing, monitoring, and approving electronic documents either through a central location, or integrated as a plugin, widgets, or other methods of integration in other systems, wherein at least one document is uploaded and stored to a user-defined location; wherein the uploader, administrator, or other related user may specify at least one user, a group of users, or at least one team that is required for approving said documents; wherein the required user or users can be immediately notified that there is a document pending the user's approval; wherein the required user or users approve or disapprove said documents, which may include comments for the decision; wherein the approval or disapproval is immediately recorded and may be viewed by other members of the approval process, with the option to send a notification once users have approved or disapproved said documents.

2. The method of claim 1, wherein the user-defined location is set by the main system in subsequent storage folders; or if the system is integrated as a plugin, widget, or other method of integration, the user-defined location is set by the installation, system administrator, or other user who has valid permissions for storage location, which may be in the same location or external location, such as an external drive.

3. The method of claim 2, wherein the central system may be web-based for the public, stored internally within a network for only employees, or other system methods; and subsequent storage folders are defined by the installation process, or later modified in the application settings.

4. The method of claim 1, wherein immediate notification may be by e-mail, text message, or other method or combination of methods of electronic or non-electronic notification.

5. The method of claim 1, wherein the approval recording can be at least a timestamp for when each user approved said document.
